(19) United States
(12) Patent Application Publication
(10) Pub. No.: US 2014/0115534 A1
(43) Pub. Date: Apr. 24, 2014

(54) INTERACTION METHOD AND APPARATUS FOR ELECTRONIC DEVICES

(71) Applicant: Huawei Technologies Co., Ltd., Shenzhen (CN)

(72) Inventors: Jun Yuan, Shenzhen (CN); Hao Wu, Shenzhen (CN)

(73) Assignee: Huawei Technologies Co., Ltd., Shenzhen (CN)

(21) Appl. No.: 14/143,929

(22) Filed: Dec. 30, 2013

Related U.S. Application Data
(63) Continuation of application No. PCT/CN2011/076894, filed on Jul. 6, 2011.

(51) Int. Cl. G06F 3/0481

(52) U.S. Cl. CPC G06F 3/0481
USPC 715/800

(57) ABSTRACT

Embodiments of the present invention provide an interaction method and apparatus for electronic devices. The method includes: generating a visible interface, where the visible interface includes at least two different display areas; detecting a current hot spot and determining a display area corresponding to the current hot spot as a hot spot display area; and stretching the hot spot display area along a direction of a display area other than the hot spot display area. The apparatus includes an interface generation unit, a hot spot detection unit, and an area stretching unit. The interaction method and apparatus for electronic devices provided in the embodiments of the present invention can stretch the display area a user is paying attention to, thereby improving interaction effects of electronic devices.

### CROSS-REFERENCE TO RELATED APPLICATIONS

This application is a continuation of International Application No. PCT/CN2011/076894, filed on Jul. 6, 2011, which is hereby incorporated by reference in their entireties

### TECHNICAL FIELD

Embodiments of the present invention relates to the field of man-machine interaction technologies, and in particular, to an interaction method and apparatus for electronic devices.

### BACKGROUND

With the rapid development of electronic technologies, electronic devices have been diversified, such as notebook computers, tablet computers, smart phones, and e-books. An electronic device usually provides a good man-machine interface on which a user may use multiple input manners, such as a manner of using a mouse, key board, or touch screen to perform operations. A display apparatus of an electronic device displays corresponding operation results to a user.

In the prior art, an electronic device usually provides indexes of contents that a user needs to browse in the form of a thumbnail list or word list. When the user needs to browse the detailed content of an object in the list, the user needs to click the object. The electronic device then displays corresponding detailed information of this object for the user by opening a new page. After checking the details, the user needs to close this detail page or return to the previous list. In this way, the user needs to frequently open and close pages that display detailed information or perform return operations, which causes low browsing efficiency.

To overcome technology flaws in the foregoing method, the prior art further provides another method, where an electronic device displays list information and detailed information simultaneously for a user. However, due to restriction from display space, the display effect is poor.

### SUMMARY

Embodiments of the present invention provide an interaction method and apparatus for electronic devices to improve interaction effects of electronic devices.

An embodiment of the present invention provides an interaction method for electronic devices, including:

generating a visual interface, where the visual interface includes at least two different display areas;

detecting a current hot spot and determining a display area corresponding to the current hot spot as a hot spot display area; and

stretching the hot spot display area along a direction of a display area other than the hot spot display area.

An embodiment of the present invention provides an interaction apparatus for electronic devices, including:

an interface generation unit, configured to generate a visual interface, where the visual interface includes at least two different display areas;

a hot spot detection unit, configured to detect a current hot spot and determine a display area corresponding to the current hot spot as a hot spot display area; and

an area stretching unit, configured to stretch the hot spot display area along a direction of a display area other than the hot spot display area.

As can be seen from the foregoing technical solutions, in the interaction method and apparatus for electronic devices provided in the embodiments of the present invention, a visual interface including at least two different display areas is generated, a display area corresponding to a current hot spot is determined as a hot spot display area, and the hot spot display area is stretched along a direction of a display area other than the hot spot display area. This increases display space of the display area a user is paying attention to and may display content of the hot spot display area in more details. The user can stretch the display area the user is paying attention to only by changing the current hot spot instead of performing open and close operations frequently, thereby improving interaction effect of electronic devices.

### BRIEF DESCRIPTION OF DRAWINGS

To illustrate the technical solutions in the embodiments of the present invention more clearly, the following briefly introduces the accompanying drawings required for describing the embodiments or the prior art. Apparently, the accompanying drawings in the following description show merely some embodiments of the present invention, and persons of ordinary skill in the art may still derive other drawings from these accompanying drawings without creative efforts.

FIG. 1 is a flowchart of an interaction method for electronic devices in Embodiment 1 of the present invention;

FIG. 2 is a flowchart of an interaction method for electronic devices in Embodiment 2 of the present invention;

FIG. 3 is a flowchart of an interaction method for electronic devices in Embodiment 3 of the present invention;

FIG. 4 is a schematic operation diagram for Web page interaction in Embodiment 4 of the present invention;

FIG. 5 is a schematic diagram for underlying operating area division in Embodiment 4 of the present invention;

FIG. 6 is another schematic operation diagram for Web page interaction in Embodiment 4 of the present invention;

FIG. 7 is another schematic diagram for underlying operating area division in Embodiment 4 of the present invention;

FIG. 8 is a schematic structural diagram of an interaction apparatus for electronic devices in Embodiment 5 of the present invention;

FIG. 9 is a schematic structural diagram of an interaction apparatus for electronic devices in Embodiment 6 of the present invention; and

FIG. 10 is a schematic structural diagram of an interaction apparatus for electronic devices in Embodiment 7 of the present invention.

### DESCRIPTION OF EMBODIMENTS

The following clearly describes the technical solutions in embodiments of the present invention with reference to the accompanying drawings in the embodiments of the present invention. Apparently, the described embodiments are merely a part rather than all of the embodiments of the present invention. All other embodiments obtained by persons of ordinary skill in the art based on the embodiments of the present invention without creative efforts shall fall within the protection scope of the present invention.

### Embodiment 1

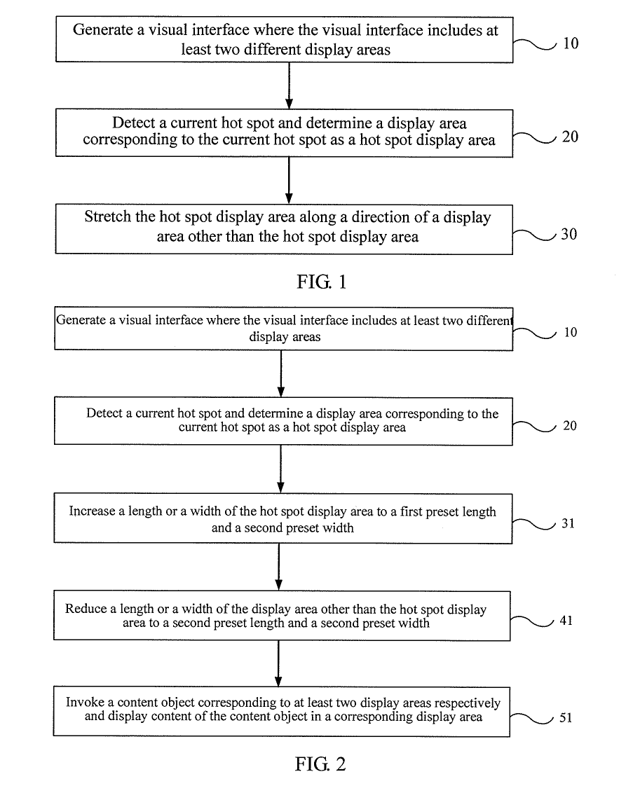

FIG. 1 is a flowchart of an interaction method for electronic devices in Embodiment 1 of the present invention. As shown in FIG. 1, the interaction method for electronic devices provided in the embodiment of the present invention may be used for but not limited to man-machine interactions of electronic devices. The interaction method for electronic devices may be executed by a control apparatus of an electronic device and implemented in the form of hardware and software.

The interaction method for electronic devices provided in this embodiment includes the following steps:

Step 10: Generate a visual interface, where the visual interface includes at least two different display areas.

Each display area may be specifically used to display different content, or one display area therein is used to display a thumbnail list or a word list, while at least one of other display areas is used to display corresponding information of an object on the list.

Step 20: Detect a current hot spot and determine a display area corresponding to the current hot spot as a hot spot display area.

The current hot spot may be specifically a motion track of a mouse left on a screen or a finger movement of a user using a touch screen. The display area where the current hot spot resides is taken as the hot spot display area, indicating that attention focus of the user is on the display area.

Step 30: Stretch the hot spot display area along a direction of a display area other than the hot spot display area.

The stretching the hot spot display area along a direction of a display area other than the hot spot display area may be specifically stretching the hot spot display area in horizontal, vertical, or diagonal direction. The implementation manner may be set according to layout of each display area on the visual interface. When the hot spot display area is stretched, display space and display content of the display area other than the hot spot display area may remain unchanged. The stretched hot spot display area partially covers other display areas. The display area other than the hot spot display area may also be dimmed to highlight the hot spot display area. The display area other than the hot spot display area may further contract as the hot spot display area is stretched.

Content displayed after the hot spot display area is stretched may be detailed information or relative information of content displayed before stretching. If the content displayed before the hot spot display area is stretched is an image, the content displayed after stretching may be an enlarged image or a clearer image of a high resolution. The content displayed in the display area and in the stretched hot spot display area may be set according to actual content display requirements and is not limited by the embodiment of the present invention.

In the interaction method for electronic devices provided in this embodiment, a visual interface including at least two different display areas is generated, a display area corresponding to a current hot spot is determined as a hot spot display area, and the hot spot display area is stretched along a direction of a display area other than the hot spot display area. This increases display space of the display area the user is paying attention to and may display the content of the hot spot display area in more details. The user can stretch the display area the user is paying attention to only by changing the current hot spot instead of performing open and close operations frequently, thereby improving interaction effect of electronic devices.

In this embodiment, when step 30 is performed to stretch the hot spot display area along the direction of the display area other than the hot spot display area, the hot spot display area partially covers the display area other than the hot spot display area. At this time, the display area other than the hot spot display area may remain unchanged. The display area other than the hot spot display area may also be dimmed to highlight the hot spot display area.

In this embodiment, only the hot spot display area needs to be stretched, and the display area other than the hot spot display area may remain unchanged, that is, after each display area in the visual interface is stretched and the current hot spot falls on a display area, it is only required to place the display area on other display areas. When the current hot spot switches from a display area to another, the display area that is stretched before may automatically restore to its initial size.

In this embodiment, when step 30 is performed to stretch the hot spot display area along the direction of the display area other than the hot spot display area, step 40 may be simultaneously performed to compress the display area other than the hot spot display area along a stretching direction of the hot spot display area. When the hot spot display area is stretched, the display area other than the hot spot display area is compressed correspondingly so that the display areas do not overlap.

In this embodiment, specifically, a compressed display area is attached to a boundary or a corner of a stretched display area as a label. The hot spot display area may be stretched to occupy display space of the whole visual interface, presenting for the user in a maximum display form. At this time, the compressed display area is attached to the boundary or corner of the stretched display area as a label. When the current hot spot falls on the label, the label may be restored to an original display area and be stretched.

### Embodiment 2

An interaction method for electronic devices provided in this embodiment is a specific implementation manner of Embodiment 1.

In this embodiment, the stretching the hot spot display area along a direction of a display area other than the hot spot display area in step 30 may specifically include:

gradually increasing the length and the width of the hot spot display area to a first preset length and a second preset width, respectively, to stretch the hot spot display area.

In this embodiment, the compressing the display area other than the hot spot display area along a stretching direction of the hot spot display area in step 40 may specifically include:

gradually reducing the length and the width of the display area other than the hot spot display area to a second preset length and a second preset width, respectively, to compress the display area other than the hot spot display area.

In this embodiment, when the at least two display areas are stretched or compressed, displayed content in each display area is dynamically zoomed in or out as the display areas are stretched or compressed; or the displayed content in each display area is dynamically increased or decreased as the display areas are stretched or compressed.

In this embodiment, the dynamically increasing or decreasing the displayed content in the at least two display areas as the display areas are stretched or compressed may specifically include the following steps:

invoking a content object corresponding to each of the at least two display areas respectively and displaying content of the content object in the corresponding display area, where, specifically, the content of the content object may be dynamically generated according to background information, and when the interaction method for electronic devices provided in the embodiment of the present invention is applied to Web page interaction, a Javascript object may be used as the content object.

FIG. 2 is a flowchart of an interaction method for electronic devices in Embodiment 2 of the present invention. As shown in FIG. 2, a specific process of the interaction method for electronic devices provided in this embodiment may be as follows:

Step 10: Generate a visual interface, where the visual interface includes at least two different display areas.

Step 20: Detect a current hot spot and determine a display area corresponding to the current hot spot as a hot spot display area.

Step 31: Gradually increase the length and the width of the hot spot display area to a first preset length and a second preset width, respectively.

Step 41: Gradually reduce the length and the width of the display area other than the hot spot display area to a second preset length and a second preset width, respectively.

Step 51: Invoke a content object corresponding to the at least two display areas respectively and display content of the content obj ect in the corresponding display area.

It should be noted that step 31 and step 41 are executed simultaneously, and are not subject to a specific time sequence during execution.

### Embodiment 3

An interaction method for electronic devices provided in this embodiment is another specific implementation manner of Embodiment 1.

In this embodiment, after step 10 is performed to generate a visual interface, where the visual interface includes at least two different display areas and before step 20 is performed to detect a current hot spot and determine a display area corresponding to the current hot spot as a hot spot display area, the following steps may be further included:

Step 60: Divide the visual interface into at least two underlying operating areas, where each display area at least covers one underlying operating area.

The dividing the visual interface into at least two underlying operating areas is specifically division of a physical interface of the visual interface. The total display area of all the underlying operating areas is the display area of the visual interface. For example, if the display area of the visual interface is 900 pixel×600 pixel and the visual interface is divided into three underlying operating areas, the display area of each underlying operating area is 300 pixel×600 pixel.

Step 70: Assign a grade to each of the underlying operating areas.

The stretching the hot spot display area along a direction of a display area other than the hot spot display area in step 30 may specifically include the following steps:

Step 301: Acquire a highest grade of an underlying operating area in the hot spot display area as an attention grade.

Step 302: Acquire at least one underlying operating area as an auxiliary area, where the underlying operating area is neighboring to the hot spot display area and with a grade lower than the attention grade.

Step 303: Combine the hot spot display area and the auxiliary area.

Through acquiring at least one underlying operating area as an auxiliary area, where the underlying operating area is neighboring to the hot spot display area and with a grade lower than the attention grade, and combining the hot spot display area and the auxiliary area, the hot spot display area is stretched. The display area other than the hot spot display area may remain unchanged or be compressed by subtracting the auxiliary area when the auxiliary area used for combination is an underlying operating area included in one or more display areas in the display area other than the hot spot display area.

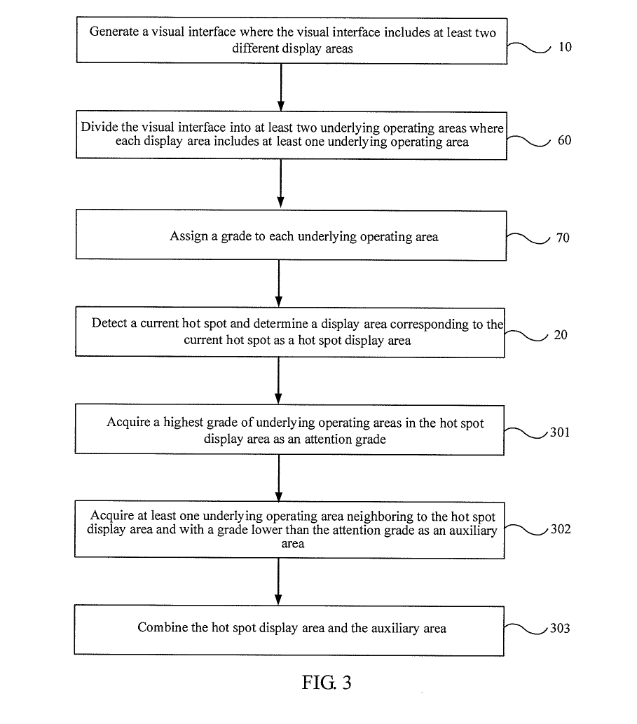

FIG. 3 is a flowchart of an interaction method for electronic devices in Embodiment 2 of the present invention. As shown in FIG. 3, a specific process of the interaction method for electronic devices provided in the embodiment of the present invention may be as follows:

Step 10: Generate a visual interface, where the visual interface includes at least two different display areas.

Step 60: Divide the visual interface into at least two underlying operating areas, where each display area at least covers one underlying operating area.

Step 70: Assign a grade to each of the underlying operating areas.

Step 20: Detect a current hot spot and determine a display area corresponding to the current hot spot as a hot spot display area.

Step 301: Acquire a highest grade of an underlying operating area in the hot spot display area as an attention grade.

Step 302: Acquire at least one underlying operating area as an auxiliary area, where the underlying operating area is neighboring to the hot spot display area and with a grade lower than the attention grade.

Step 303: Combine the hot spot display area and the auxiliary area.

### Embodiment 4

In this embodiment, at least two different display areas may include a first display area and a second display area. The first display area is used to display at least one marked graph, where the marked graph is used to indicate specified content. The second display area is used to display brief information of at least one marked graph in the first display area. If the first display area is a hot spot display area, the second display area displays brief information of a marked graph in the first display area. If the second display area is the hot spot display area, the brief information displayed in the second display area is unfolded into detailed information. The marked graph may be in icon form or in text form. The first display area may be a list area including multiple marked graphs. The second display area may be brief information corresponding to a marked graph in the list area.

The following example uses a Web page as an example to specifically describe the interaction method for electronic devices provided in the embodiment of the present invention.

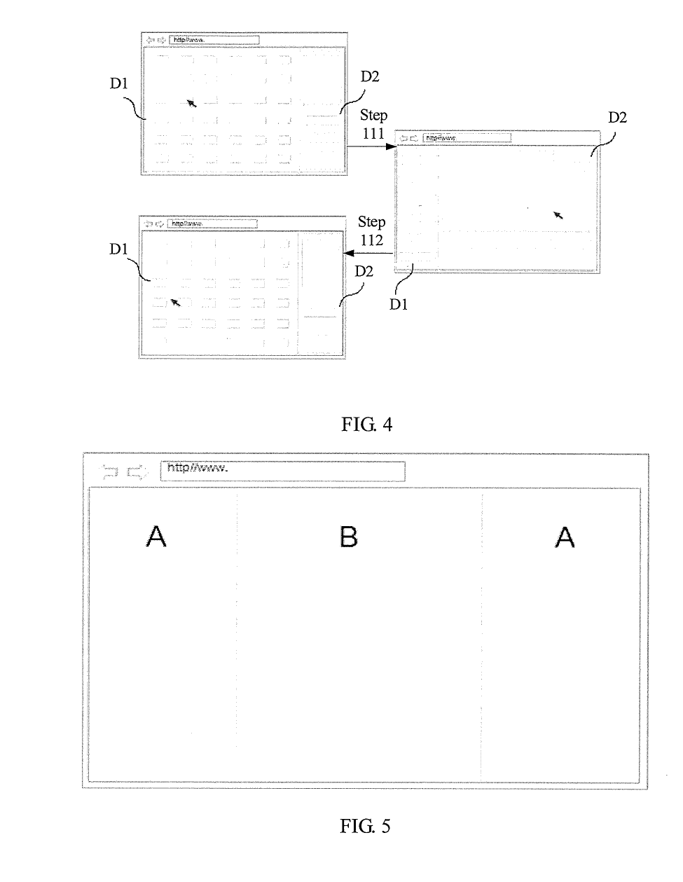

FIG. 4 is a schematic operation diagram for Web page interaction in Embodiment 4 of the present invention. As shown in FIG. 4, a visual interface is generated. The visual interface may be specifically a Web page displayed in a browser. The visual interface includes two display areas with D1 as the first display area and D2 as the second display area. The first display area D1 and the second display area D2 are laterally distributed. The first display area D1 displays multiple marked graphs, and the second display area D2 displays brief information of a marked graph displayed in the first display area D1. Initial content of the second display area D2 may be brief information of a first marked graph in the first display area D1. The brief information may include specifically a contracted form of an image and brief text description. A user may choose to click a marked graph in the first display area D1 to display its corresponding brief information in the second display area D2.

When the user needs to browse detailed information of the marked graph, the user switches a current hot spot to the second display area D2 (step 111) and stretches the second display area D2 along a direction of the first display area D1. The brief information displayed in the second display area D2 is unfolded into detailed information. The detailed information may include specifically an enlarged form of an image and detailed text description. At this time, the size and content of the first display area D1 remain unchanged. The second display area D2 is presented to the user by partially covering the first display area D1.

After the user completes browsing the detailed information in the second display area D2, the user switches the current hot spot to the first display area D1 (Step 112). Because the size and content of the first display area D1 remain unchanged when the second display area D2 is stretched, the first display area D1 may be directly displayed as a top layer, and at this time, the second display area D2 may be restored to its initial state and display brief information.

The stretching the second display area D2 may be implemented by using the method provided in Embodiment 2, that is, increasing the length and the width of the second display area D2 to a first preset length and a second preset width. The second display area D2 may also be stretched using the method provided in Embodiment 3. FIG. 5 is a schematic diagram for underlying operating area division in Embodiment 4 of the present invention. As shown in FIG. 5, the visual interface may be divided into three underlying operating areas from left to right. The three underlying operating areas are respectively a first underlying operating area, a second underlying operating area, and a third underlying operating area. In initial state, the first display area D1 includes the first and second underlying operating areas, and the second display area D2 includes the third underlying operating area. The grade of the first underlying operating area is A, the grade of the second underlying operating area is B, and the grade of the third underlying operating area is A. When the user switches the current hot spot to the second display area D2, the second display area D2 acquires and is combined with the second underlying operating area to stretch the second display area D2.

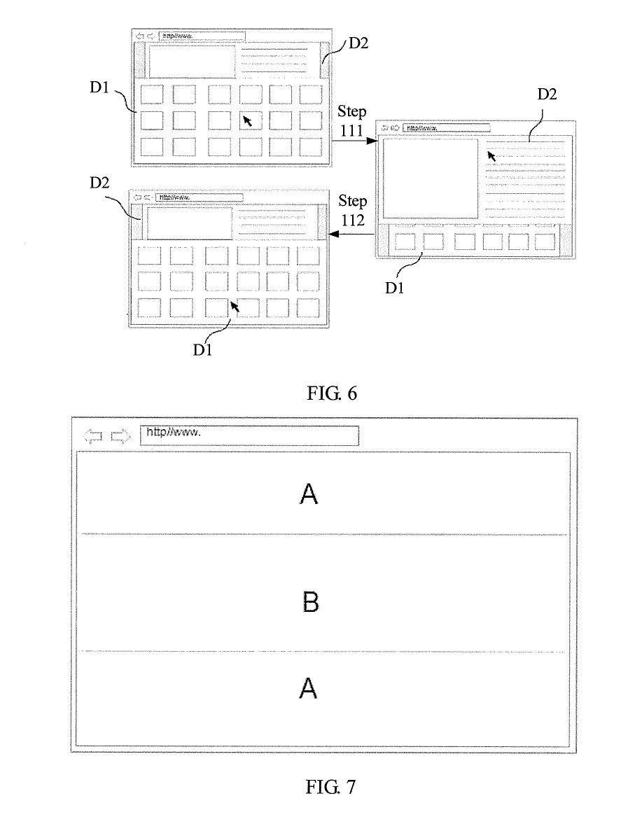

FIG. 6 is another schematic operation diagram for Web page interaction in Embodiment 4 the present invention. As shown in FIG. 6, a generated visual interface includes two display areas: a first display area D1 and a second display area D2. The first display area D1 and the second display area D2 are longitudinally distributed. A Web page interaction process in FIG. 6 is similar to that in FIG. 4 and is not described here again. In the Web page interaction process in FIG. 6, when the second display area D2 is stretched by using the method provided in Embodiment 3, an underlying operating area division manner shown in FIG. 7 may be specifically used.

### Embodiment 5

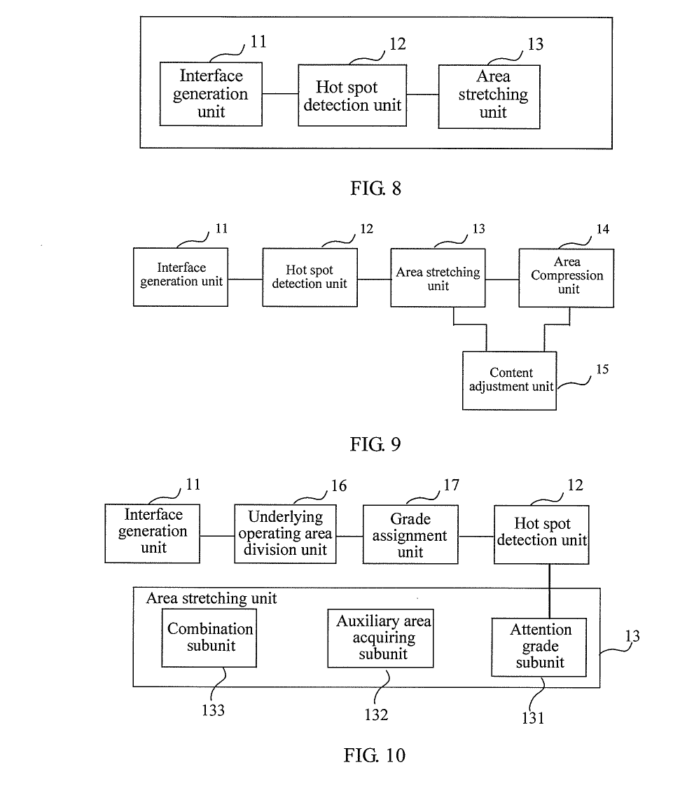

FIG. 8 is a schematic structural diagram of an interaction apparatus for electronic devices in Embodiment 5 of the present invention. As shown in FIG. 8, the interaction apparatus for electronic devices provided in this embodiment may specifically implement steps of the interaction method for electronic devices provided in the forgoing embodiments. The interaction apparatus may be integrated in a control apparatus of an electronic device or be set independently.

The interaction apparatus for electronic devices provided in this embodiment specifically includes an interface generation unit 11, a hot spot detection unit 12, and an area stretching unit 13. The interface generation unit 11 is configured to generate a visual interface, where the visual interface includes at least two different display areas. The hot spot detection unit 12 is configured to detect a current hot spot and determine a display area corresponding to the current hot spot as a hot spot display area. The area stretching unit 13 is configured to stretch the hot spot display area along a direction of a display area other than the hot spot display area.

For an implementation process of man-machine interaction using the interaction apparatus for electronic devices provided in this embodiment, reference may be made to an implementation process of the interaction method for electronic devices provided in the foregoing embodiments, which is not described here again.

In the interaction apparatus for electronic devices provided in this embodiment, the interface generation unit 11 generates a visual interface including at least two different display areas; the hot spot detection unit 12 determines a display area corresponding to a current hot spot as a hot spot display area; and the area stretching unit 13 stretches the hot spot display area along a direction of a display area other than the hot spot display area. This increases display space of the display area the user is paying attention to and may display content of the hot spot display area in more details. The user can stretch the display area the user is paying attention to only by changing the current hot spot instead of performing open and close operations frequently, thereby improving interaction effect of electronic devices.

### Embodiment 6

FIG. 9 is a schematic structural diagram of an interaction apparatus for electronic devices in Embodiment 6 of the present invention. As shown in FIG. 9, in this embodiment, when the area stretching unit 13 is configured to stretch the hot spot display area along the direction of the display area other than the hot spot display area, the hot spot display area partially covers the display area other than the hot spot display area.

In this embodiment, the area stretching unit 13 may be further configured to gradually increase the length and the width of the hot spot display area to a hot spot preset length and a hot spot preset width, respectively.

In this embodiment, the interaction apparatus for electronic devices may further include an area compression unit 14, configured to compress the display area other than the hot spot display area along a stretching direction of the hot spot display area when the area stretching unit 13 stretches the hot spot display area along the direction of the display area other than the hot spot display area.

In this embodiment, the area compression unit 14 may be further configured to gradually reduce the length and the width of the display area other than the hot spot display area to a second preset length and a second preset width, respectively.

In this embodiment, the area compression unit 14 may be further configured to attach a compressed display area to a boundary or a corner of a stretched display area as a label.

In this embodiment, the interaction apparatus for electronic devices may further include a content adjustment unit 15, configured to dynamically zoom in or out content displayed in the at least two display areas as the display areas are stretched or compressed; or dynamically increase or reduce the content displayed in the at least two display areas as the display areas are stretched or compressed.

### Embodiment 7

FIG. 10 is a schematic structural diagram of an interaction apparatus for electronic devices in Embodiment 7 of the present invention. As shown in FIG. 10, in this embodiment, the interaction apparatus for electronic devices may further include an underlying operating area division unit 16 and a grade assignment unit 17. The underlying operating area division unit 16 is configured to divide a visual interface into at least two underlying operating areas, where each of display areas at least covers one underlying operating area. The grade assignment unit 17 is configured to assign a grade to each of the underlying operating areas.

An area stretching unit 13 includes an attention grade subunit 131, an auxiliary area acquiring subunit 132, and a combination subunit 133. The attention grade subunit 131 is configured to acquire a highest grade of an underlying operating area in a hot spot display area as an attention grade. The auxiliary area acquiring unit 132 is configured to acquire at least one underlying operating area as an auxiliary area, where the underlying operating area is neighboring to the hot spot display area and with a grade lower than the attention grade. The combination subunit 133 is configured to combine the hot spot display area and the auxiliary area.

Persons of ordinary skill in the art should understand that, all or part of the steps of the foregoing method embodiments may be implemented by a program instructing relevant hardware. The foregoing program may be stored in a computer readable storage medium. When the program runs, the above steps included in the method embodiments are performed. The foregoing storage medium may be any medium capable of storing program codes, such as a ROM, a RAM, a magnetic disk, or an optical disk.

Finally, it should be noted that the foregoing embodiments are merely intended for describing the technical solutions of the present invention rather than limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof; without departing from the spirit and scope of the technical solution of the embodiments of the present invention.

What is claimed is:

1. An interaction method for electronic devices, the method comprising:
generating a visual interface, wherein the visual interface comprises at least two different display areas;
detecting a current hot spot and determining a display area corresponding to the current hot spot as a hot spot display area; and
stretching the hot spot display area along a direction of a display area other than the hot spot display area.

2. The interaction method for electronic devices according to claim 1, wherein:
when the hot spot display area is stretched along the direction of the display area other than the hot spot display area, the hot spot display area partially covers the display area other than the hot spot display area.

3. The interaction method for electronic devices according to claim 1, wherein stretching the hot spot display area along a direction of a display area other than the hot spot display area comprises:
gradually increasing the length and the width of the hot spot display area to a first preset length and a first preset width, respectively.

4. The interaction method for electronic devices according to claim 1, further comprising:
compressing the display area other than the hot spot display area along a stretching direction of the hot spot display area when stretching the hot spot display area along the direction of the display area other than the hot spot display area.

5. The interaction method for electronic devices according to claim 4, wherein: compressing the display area other than the hot spot display area along a stretching direction of the hot spot display area comprises:
gradually reducing the length and the width of the display area other than the hot spot display area to a second preset length and a second preset width, respectively.

6. The interaction method for electronic devices according to claim 4, wherein:
the compressed display area is attached to a boundary or a corner of the stretched display area as a label.

7. The interaction method for electronic devices according to claim 1, wherein:
after generating a visual interface, wherein the visual interface comprises at least two different display areas, and before detecting a current hot spot and determining a display area corresponding to the current hot spot as a hot spot display area, the method further comprises:
dividing the visual interface into at least two underlying operating areas, wherein each of the display areas at least covers one underlying operating area; and
assigning a grade to each of the underlying operating areas, wherein stretching the hot spot display area along a direction of a display area other than the hot spot display area comprises:
acquiring a highest grade of an underlying operating area in the hot spot display area as an attention grade;
acquiring at least one underlying operating area as an auxiliary area, wherein the underlying operating area is neighboring to the hot spot display area and with a grade lower than the attention grade; and
combining the hot spot display area and the auxiliary area.

8. The interaction method for electronic devices according to claim 4, comprising:
dynamically zooming in or out displayed content in the at least two display areas as the display areas are stretched or compressed; or
dynamically increasing or decreasing the displayed content in the at least two display areas as the display areas are stretched or compressed.

9. The interaction method for electronic devices according to claim 8, wherein dynamically increasing or decreasing the displayed content in the at least two display areas as the display areas are stretched or compressed comprises:
invoking a content object corresponding to the at least two display areas respectively and displaying content of the content object in the corresponding display area.

10. The interaction method for electronic devices according to claim 1, wherein:
the at least two different display areas comprise a first display area and a second display area, wherein the first display area is used to display at least one marked graph, wherein the marked graph is used to indicate specified content, and the second display area is used to display brief information of at least one marked graph in the first display area; and
if the first display area is the hot spot display area, the second display area displays brief information of a marked graph in the first display area; and if the second display area is the hot spot display area, the brief information displayed in the second display area is unfolded into detailed information.

11. An interaction apparatus for electronic devices, the apparatus comprising:
an interface generation unit, configured to generate a visual interface, wherein the visual interface comprises at least two different display areas;
a hot spot detection unit, configured to detect a current hot spot and determine a display area corresponding to the current hot spot as a hot spot display area; and
an area stretching unit, configured to stretch the hot spot display area along a direction of a display area other than the hot spot display area.

12. The interaction apparatus for electronic devices according to claim 11, wherein:
when the area stretching unit stretches the hot spot display area along the direction of the display area other than the hot spot display area, the hot spot display area partially covers the display area other than the hot spot display area.

13. The interaction apparatus for electronic devices according to claim 11, wherein:
the area stretching unit is further configured to gradually increase the length and the width of the hot spot display area to a first preset length and a second preset width, respectively.

14. The interaction apparatus for electronic devices according to claim 11, further comprising:
an area compression unit, configured to compress the display area other than the hot spot display area along a stretching direction of the hot spot display area when the area stretching unit stretches the hot spot display area along the direction of the display area other than the hot spot display area.

15. The interaction apparatus for electronic devices according to claim 14, wherein:
the area compression unit is further configured to gradually reduce the length and the width of the display area other than the hot spot display area to a second preset length and a second preset width, respectively.

16. The interaction apparatus for electronic devices according to claim 14, wherein:
the area compression unit is further configured to attach a compressed display area to a boundary or a corner of a stretched display area as a label.

17. The interaction apparatus for electronic devices according to claim 11, further comprising: an underlying operating area division unit and a grade assignment unit, wherein:
the underlying operating area division unit is configured to divide the visual interface into at least two underlying operating areas, wherein each of display areas at least covers one underlying operating area; and
the grade assignment unit is configured to assign a grade to each of the underlying operating areas, wherein
the area stretching unit comprises:
an attention grade subunit, configured to acquire a highest grade of an underlying operating area in the hot spot display area as an attention grade;
an auxiliary area acquiring subunit, configured to acquire at least one underlying operating area as an auxiliary area, wherein the underlying operating area is neighboring to the hot spot display area and with a grade lower than the attention grade; and
a combination subunit, configured to combine the hot spot display area and the auxiliary area.

18. The interaction apparatus for electronic devices according to claim 14, further comprising: a content adjustment unit, wherein
the content adjustment unit is configured to dynamically zoom in or out content displayed in the at least two display areas as the display areas are stretched or compressed; or dynamically increase or reduce the content displayed in the at least two display areas as the display areas are stretched or compressed.
